(19) United States
(12) Patent Application Publication
(10) Pub. No.: US 2011/0109547 A1
(43) Pub. Date: May 12, 2011

(54) POSITION REMOTE CONTROL SYSTEM FOR WIDGET

(76) Inventors: Yung-Chih Lin, Taipei Hsien (TW); Po-Hsu Chen, Taipei Hsien (TW); Bor-Lun Chang, Taipei Hsien (TW)

(21) Appl. No.: 12/773,802

(22) Filed: May 4, 2010

(30) Foreign Application Priority Data
Nov. 10, 2009 (TW) 098138059

(51) Int. Cl. G06F 3/033

(52) U.S. Cl. 345/158

(57) ABSTRACT

A position remote control system for a widget is disclosed. The position remote control system is utilized for controlling positions of a plurality of widgets on a display device, and includes a remote controller for selecting one of the plurality of widgets and a corresponding target position and accordingly generating a remote control signal, and a display module including a first wireless device for receiving the remote control signal, an interpreter coupled to the first wireless device for interpreting the remote control signal to generate a first display signal, and a display unit coupled to the interpreter for displaying the widget window on a display area of the display device according to the first display signal.

### BACKGROUND OF THE INVENTION

1. Field of the Invention

The present invention is related to a position remote control system for a widget, and more particularly, to a position remote control system controlling positions of widgets displayed on a display device by a remote controller.

2. Description of the Prior Art

With advances in technology, boundaries between household appliances and technology information products have become thinner and thinner. For example, modern televisions (TV) can display a smart information window called a “Widget”, previously employed only in information technology products such as personal computers (PC). A user can choose various widget functions, such as displaying the latest news, global time information, weather information, currency exchange rates, stock prices, etc. via a remote controller or functional keypads of the TV. As a result, the user can simultaneously watch TV and receive constantly updated information.

Even though the TV can display widgets, without a mouse, the widgets displayed on the TV cannot be moved as freely as on a PC screen. The user has to press the functional keypads installed on a TV case to move the widgets to desired positions. In general, the positions of the widgets are fixed on the TV. Therefore, any change of contents of a displaying TV program may affect reception quality of the user. For example, as illustrated in FIG. 1A and FIG. 1B, when program contents displayed by a TV 10 are varied, partial program contents are covered by widgets with fixed positions, causing inconvenience to the user. In such a situation, the user only can move the widgets away via a keypad set 100 installed on a case of the TV 10. That is, the user has to move to the front of the TV 10 to operate the keypad set 100. Obviously, such a procedure is inconvenient for the user.

Therefore, providing a convenient method for the user to move the widgets without modifying their existing TV watching habits has become a major focus of the industry.

### SUMMARY OF THE INVENTION

It is therefore a primary objective of the claimed invention to provide a position remote control system for a widget.

The present invention discloses a position remote control system for a widget. The position remote control system is utilized for controlling positions of a plurality of widgets on a display device, and comprises a remote controller for selecting one of the plurality of widgets and indicating a corresponding target position to accordingly generate a remote control signal, and a display module comprising a first wireless device for receiving the remote control signal, an interpreter coupled to the first wireless device for interpreting the remote control signal to generate a first display signal, and a display unit coupled to the interpreter for displaying the selected widget on a display area of the display device according to the first display signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A and FIG. 1B are schematic diagrams of a prior art television displaying widgets.

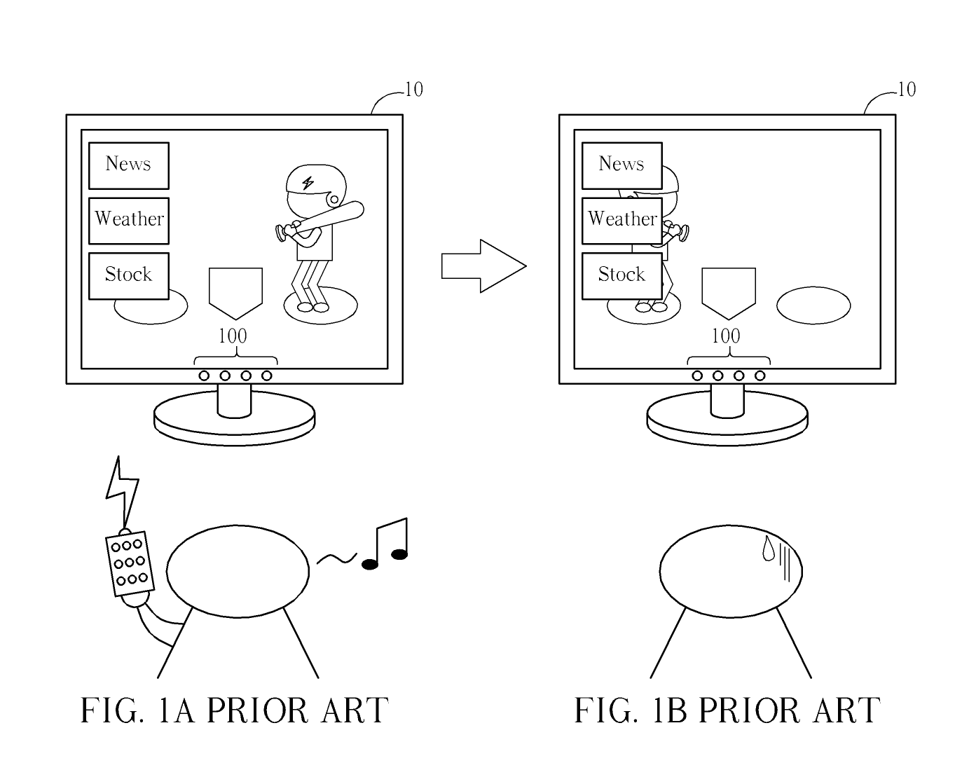

FIG. 2 is a schematic diagram of a position remote control system for a widget according to an embodiment of the present invention.

FIG. 3 is a schematic diagram of a touch remote controller according to an embodiment of the present invention.

FIG. 4 is a schematic diagram of a remote controller according to an embodiment of the present invention.

### DETAILED DESCRIPTION

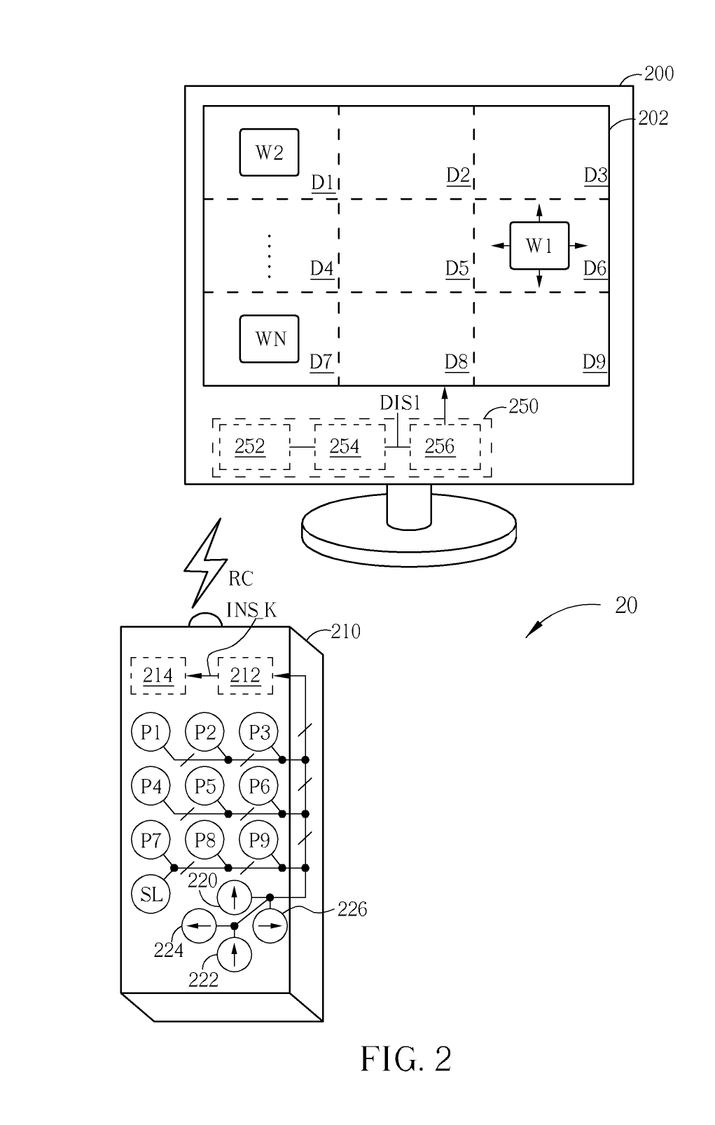

Please refer to FIG. 2, which is a schematic diagram of a position remote control system 20 for a widget according to an embodiment of the present invention. The position remote control system 20 is utilized for controlling positions of widgets W1-WN on a display device 200 like a television (TV). The position remote control system 20 includes a remote controller 210 and a display module 250. The remote controller 210 is utilized for selecting a widget WX from the widgets W1-WN and indicating a target position for the widget WX to accordingly generate a remote control signal RC. The display module 250 includes a first wireless device 252, an interpreter 254 and a display unit 256. The first wireless device 252 is utilized for receiving the remote control signal RC. Next, the interpreter 254 is utilized for interpreting the remote control signal RC to generate a first display signal DIS1. Finally, the display unit 250 displays the selected widget WX on a display area 202 of the display device 200 according to the first display signal DIS1.

In short, based upon existing operational habits for a user, the present invention enables the user to move the widgets W1-WN by the remote controller 210. To implement the widget movement function in the remote controller 210, the display module 250 is embedded in the display device 200 to identify widget movement information, such as the selected widget, the target position, etc., specified by the remote controller 210. As a result, the user can easily move the widgets W1-WN based upon TV program contents, and is no longer bothered by widgets with fixed positions.

The remote controller 210 can be implemented according to various methods. For example, if the remote controller 210 is outwardly implemented according to a traditional keypad remote controller, the remote controller 210 includes a selection keypad SL, positional keypads P1-P9, a keypad control module 212 and a second wireless device 214. The selection keypad SL is utilized for selecting a widget WX from the widgets W1-WN. In FIG. 2, the positional keypads P1-P9 respectively correspond to sub-display zones D1-D9 of the display area 202, and are utilized for indicating the target position of the selected widget WX. The keypad control module 212 is utilized for generating a keypad command INS_k according to a pressing history of the selection keypad SL and the positional keypads P1-P9. The second wireless device 214 is utilized for generating the remote control signal RC according to the keypad command INS_k.

For example, when the selection keypad SL is pressed once, the remote controller 210 is switched from a traditional channel selection mode to a widget movement mode. From this point, whenever the selection keypad SL is pressed, the selected widget jumps to the next widget, so as to select the desired widget WX. Once the selected widget WX is determined, the user can indicate the target position of the widget WX by pressing the positional keypads P1-P9. For example, the pressed positional keypad P1 represents that the user desires to move the widget WX to the sub-display zone D1. If the user desires to move the widget W2 to the sub-display zone D1, messages describing that the selection keypad SL is pressed three times and the positional keypad P1 is pressed once are sent to the keypad control module 212. In such a situation, the keypad control module 212 can accordingly generate the corresponding keypad command INS_k to wirelessly transmit the movement information to the display device 200 by the second wireless module 214. As a result, the interpreter 254 can decode the remote control signal RC received by the first wireless module 252 and conclude to “move the widget W2 to the sub-display zone D1” and generate the corresponding first display signal DIS1 to prompt the display unit 256 to update frame contents on the display area 202. Those skilled in the art will understand that the present invention is not limited to the number of keypads, allocation of the sub-display zones and the relationship between the positional keypads and the sub-display zones, etc. All these variables can be adjusted to meet different application requirements.

Note that, in FIG. 2, since the remote controller 210 merely allows the user to move the widgets W1-WN to nine specific positions, detailed adjustments to the widgets W1-WN cannot be performed. Thus, the remote controller 210 further includes tuning keypads 220, 222, 224, 226 for tuning the target position of the selected widget WX. For example, in FIG. 2, the selected widget W1 can be moved up, down, left, or right by pressing the tuning keypads 220, 222, 224, 226, respectively. In order to cooperate with the additional tuning keypads 220, 222, 224, 226, the keypad control module 212 has to identify a pressing history of the tuning keypads 220, 222, 224, 226 to generate the corresponding keypad command INS_k, so as to perform the tuning operations.

Functioning as communication media between the remote controller 210 and the display device 200, the first wireless device 252 and the second wireless device 214 can be implemented according to ultrared, wireless fidelity (WiFi), Bluetooth techniques or the like.

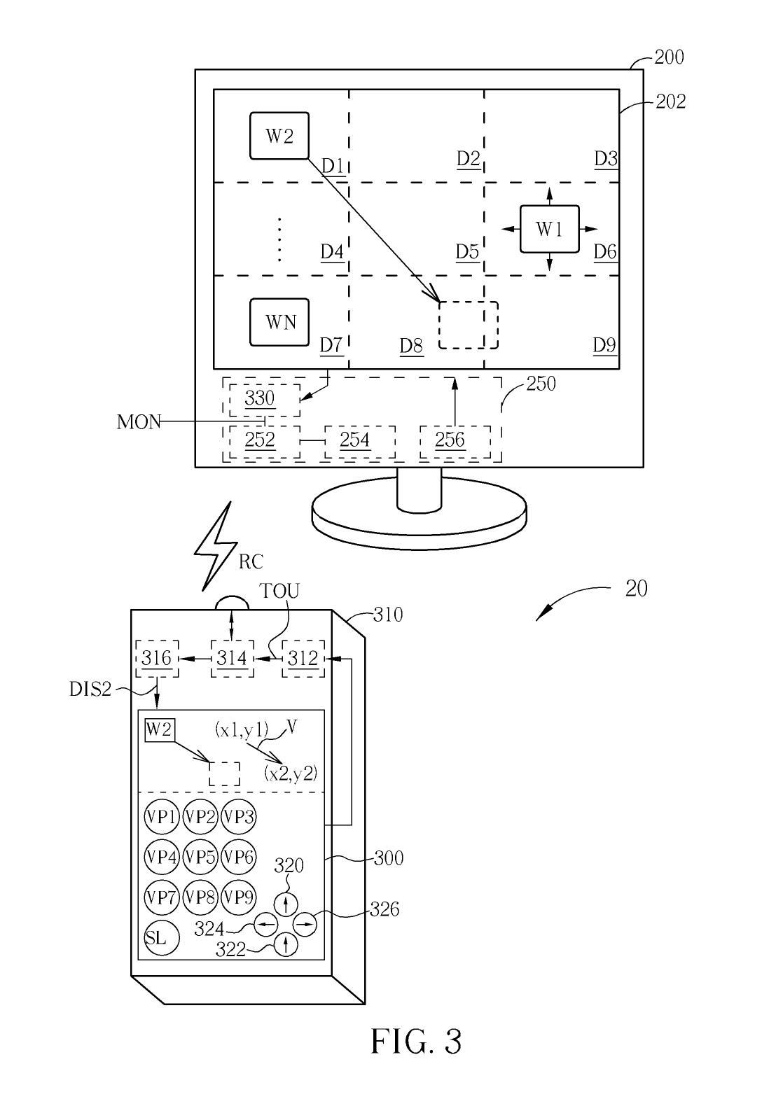

In addition to the remote controller 210 with transitional keypads, please refer to FIG. 3, which is a schematic diagram of a touch remote controller 310 according to an embodiment of the present invention. The remote controller 310 can move the widgets W1-WN by touching, and includes a touch panel 300, a touch control module 312 and a second wireless device 314. The touch panel 300 is utilized for displaying a virtual selection keypad VSL to select the desired widget WX by a clicking operation and create a vector V by a dragging operation. The touch control module 312 is utilized for generating a touch result TOU according to the selected widget WX and the vector V. The second wireless device 314 is utilized for generating the remote control signal RC according to the touch result TOU.

In practice, similar to the physical keypads, the user can select the desired widget WX by clicking the virtual selection keypad VSL. Next, the user can drag the widget for a distance on the touch panel 300 to create the vector V to indicate the target position. Correspondingly, the touch control module 312 records a starting coordinate (x₁, y₁) and an ending coordinate (x₂, y₂) when the touch panel 300 is clicked and dragged to acquire the vector V. As a result, the interpreter 254 can compute the target position of the widget WX according to an initial position of the widget WX and the vector V.

Note that, if manufacturing costs are taken into consideration, the first wireless device 252 and the second wireless device 314 preferably can be implemented according to the ultrared, wireless fidelity (WiFi), Bluetooth technique since the remote control system 20 of FIG. 3 merely has to transmit signals in one direction (from the remote controller 310 to the display device 200). Since ultrared transmitters and receivers cost much less than WiFi devices and Bluetooth devices, an overall manufacturing cost of the remote control system 20 can be reduced.

It will be appreciated that the user cannot precisely indicate the target position by simply creating the vector V. Thus, to completely enable functions of the touch panel 300, i.e. displaying current positions of widgets on the touch panel 300, the display module 250 further includes a monitor module 330. The monitor module 330 monitors positional variances of the widgets W1-WN, and accordingly generates a monitor result MON sent to the first wireless device 252. The first wireless device 252 transmits the monitor result MON to the second wireless device 314. Correspondingly, the remote controller 310 has to additionally include a touch display unit 316 for generating a second display signal DIS2 according to the monitor result MON received by the second wireless device 314. As a result, the touch panel 300 can display the latest positions of the widgets W1-WN based upon the second display signal DIS2. That is, the user can directly click and drag on the touch panel 300 to indicate the target position of the select widget WX instead of clicking the virtual selection keypad VSL and then creating the vector V. In this case, the touch control module 312 is utilized for generating the touch result TOU according to the widget WX selected by a clicking operation and the target position indicated by another clicking operation.

Other than clicking a spot on the touch panel 300, indicating the target position by pressing keypads as in the remote controller 210 is practical in the remote controller 310. For example, the touch panel 300 can display the virtual positional keypads VP1-VP9 respectively corresponding to the sub-display zones D1-D9 of the display area 202 to allow the user to indicate the target position of the widget WX. In addition, the touch panel 300 can further be utilized for displaying virtual tuning keypads 320, 322, 324, 326, such that the user can tune the position of the selected widget WX, such as the widget W1 shown in FIG. 3. Correspondingly, the touch control module 312 has to identify a pressing history of the virtual positional keypads VP1-VP9 and the virtual tuning keypads 320, 322, 324, 326 to generate the corresponding touch result TOU.

Note that, with the additional monitor module 330 and the touch display unit 316, the remote controller 310 and the display device 200 interactively communicate with each other, and thus have to be implemented according to WiFi, Bluetooth, or other compatible techniques.

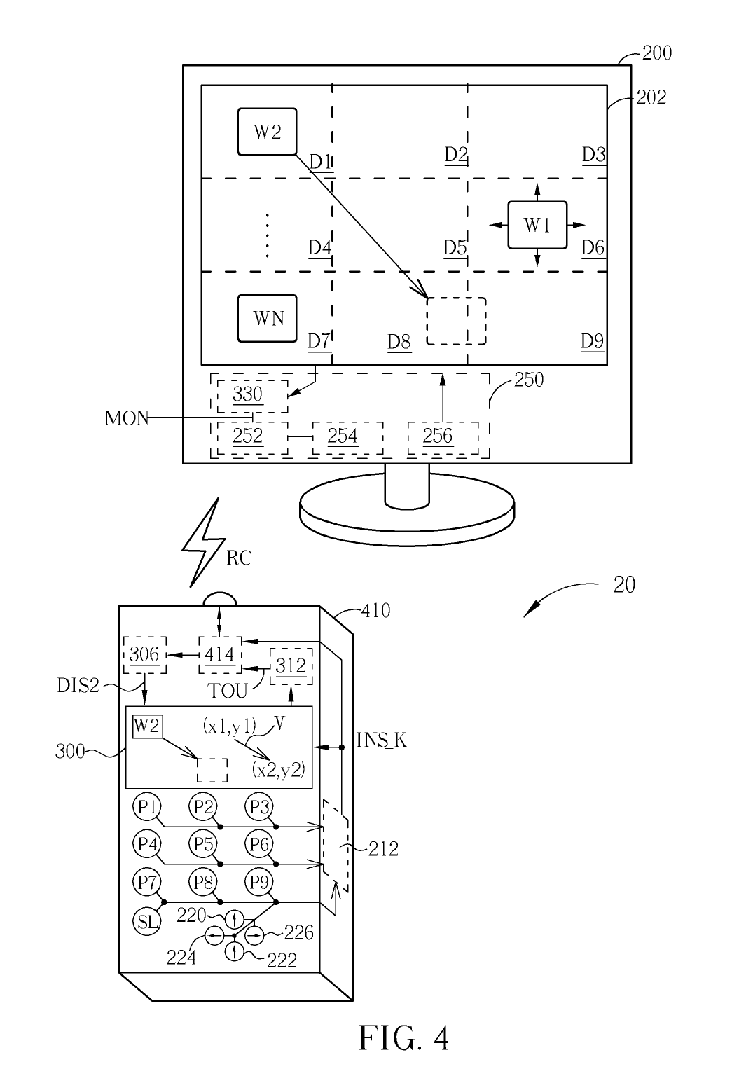

Other than the remote controller 210, 310, the present invention further provides a remote controller 410, as illustrated in FIG. 4. The remote controller 410 is an integrated version of the remote controllers 210, 310. Therefore, the remote controller 410 includes the selection keypad SL, the positional keypads P1-P9 and the keypad control module 212 originally included in the remote controller 210, and includes the touch panel 300, the touch control module 312 and a second wireless device 414 originally included in the remote controller 310. Functions and operations of the selection keypad SL, the positional keypads P1-P9, the keypad control module 212, the touch panel 300 and the touch control module 312 can be referred to in the above, and are not further narrated herein. Note that the remote controller 410 generates the remote control signal RC based upon both of the keypad command INS_k and the touch result TOU.

Since the remote control 410 both includes the physical keypads and the touch panel 300, the physical keypads and the touch panel 300 can functionally support each other, such that the user can operate the remote controller 410 more easily. For example, when the user selects the desired widget WX by the selection keypad SL, the touch panel 300 enters a standby state to be ready for receiving the vector V created by the user.

The interactive communication function of the remote controller 310 can also be applied to the remote controller 410. That is, the monitor module 330 added to the display module 250 and the touch display unit 306 added to the remote controller 410 enable the user to select the desired widget WX by clicking a spot on the touch panel 300 and move the widget WX by a dragging operation.

Similarly, the positional tuning function of the remote controller 210 can be applied to the remote controller 410. That is, the remote controller 410 can further include the tuning keypads 220, 222, 224, 226.

With both the touch panel 300 and the physical keypads, the user can select the desired widget WX not only by pressing the selection keypad SL and clicking a spot on the touch panel 300 but also by clicking the virtual selection keypad VSL displayed by the touch panel 300.

Similarly, implementation of the first wireless device 252 and the second wireless device 414 depends on practical functional requirements of the position remote control system 20. That is, if only the single direction transmission is required, the position remote control system 20 can simply be implemented according to the ultrared technique. If the dual direction transmission is required, the position remote control system 20 can be implemented according to the WiFi or Bluetooth technique.

Note that, the display module 250 is generally embedded within the display device 200, such as a TV or the like.

In the prior art, positions of widgets are fixed on a TV, and only can be moved by pressing a keypad set installed on a TV case, consequently causing inconvenience to the user. In comparison, the present invention takes existing TV watching habits into consideration and allows the user to move the positions of the widgets W1-WN via the remote controllers 210, 310, 410, such that the user can quickly move the widgets W1-WN away from important video program contents and minimize side effects of the widgets W1-WN.

To sum up, the present invention provides the position remote control system for widgets, such that the user can remotely and quickly move the widgets, while minimizing the side effects of the widgets.

Those skilled in the art will readily observe that numerous modifications and alterations of the device and method may be made while retaining the teachings of the invention.

What is claimed is:

1. A position remote control system for a widget, for controlling positions of a plurality of widgets on a display device, the position remote control system comprising:
a remote controller, for selecting one of the plurality of widgets and indicating a corresponding target position to accordingly generate a remote control signal; and
a display module, comprising:
a first wireless device, for receiving the remote control signal;
an interpreter, coupled to the first wireless device, for interpreting the remote control signal to generate a first display signal; and
a display unit, coupled to the interpreter, for displaying the selected widget on a display area of the display device according to the first display signal.

2. The position remote control system of claim 1, wherein the remote controller comprises:
a selection keypad, for selecting one of the plurality of widgets;
a plurality of positional keypads, respectively corresponding to a plurality of sub-display zones of the display area, for indicating the target position of the selected widget;
a keypad control module, coupled to the selection keypad and the plurality of positional keypads, for generating a keypad command according to a pressing history of the selection keypad and the plurality of positional keypads; and
a second wireless device, coupled to the keypad control module, for generating the remote control signal according to the keypad command.

3. The position remote control system of claim 2, wherein the remote controller further comprises a plurality of tuning keypads, coupled to the keypad control module, the keypad control module is utilized for generating the keypad command according to a pressing history of the plurality of tuning keypads, for tuning the target position of the selected widget by the keypad command.

4. The position remote control system of claim 2, wherein the first wireless device and the second wireless device are ultrared devices, wireless fidelity (WiFi) devices or Bluetooth devices.

5. The position remote control system of claim 1, wherein the remote controller comprises:
a touch panel, for displaying a virtual selection keypad to select one of the plurality of widgets by a clicking operation and create a vector by a dragging operation;
a touch control module, coupled to the touch panel, for generating a touch result according to the selected widget and the vector; and
a second wireless device, coupled to the touch control module, for generating the remote control signal according to the touch result.

6. The position remote control system of claim 5, wherein the touch control module records a starting coordinate and an ending coordinate when the touch panel is clicked and dragged to acquire the vector.

7. The position remote control system of claim 5, wherein the display module further comprises a monitor module, coupled to the first wireless device, for monitoring positional variances of the plurality of widgets to generate a monitor result, the first wireless device is utilized for transmitting the monitor result to the second wireless device.

8. The position remote control system of claim 7, wherein the remote controller further comprises a touch display unit, coupled to the second wireless device, for generating a second display signal according to the monitor result received by the second wireless device.

9. The position remote control system of claim 8, wherein the touch panel is further utilized for displaying the positions of the plurality of widgets according to the second display signal to indicate the target position of the selected widget by clicking and dragging on the touch panel.

10. The position remote control system of claim 9, wherein the touch control module is further utilized for generating the touch result according to the selected widget and the target position.

11. The position remote control system of claim 5, wherein the touch panel is further utilized for displaying a plurality of virtual positional keypads, respectively corresponding to a plurality of sub-display zones, for indicating the target position of the selected widget.

12. The position remote control system of claim 11, wherein the touch control module is further utilized for generating the touch result according to a pressing history of the plurality of virtual positional keypads.

13. The position remote control system of claim 5, wherein the touch panel is further utilized for displaying a plurality of virtual tuning keypads, for tuning the position of the selected widget.

14. The position remote control system of claim 13, wherein the touch control module is further utilized for generating the touch result according to a pressing history of the plurality of virtual tuning keypads.

15. The position remote control system of claim 5, wherein the first wireless device and the second wireless device are ultrared devices, wireless fidelity (WiFi) devices or Bluetooth devices.

16. The position remote control system of claim 1, wherein the remote controller comprises:
a selection keypad, for selecting one of the plurality of widgets;
a plurality of positional keypads, respectively corresponding to a plurality of sub-display zones of the display area, for indicating the target position of the selected widget;
a keypad control module, coupled to the selection keypad and the plurality of positional keypads, for generating a keypad command according to a pressing history of the selection keypad and the plurality of positional keypads;
a touch panel, coupled to the keypad control module, for creating a vector by a dragging operation;
a touch control module, coupled to the touch panel, for generating a touch result according to the selected widget and the vector; and
a second wireless device, coupled to the touch control module and the keypad control module, for generating the remote control signal according to the keypad command and the touch result.

17. The position remote control system of claim 16, wherein the touch control module records a starting coordinate and an ending coordinate when the touch panel is clicked and dragged to acquire the vector.

18. The position remote control system of claim 16, wherein the display module further comprises a monitor module, coupled to the first wireless device, for monitoring positional variances of the plurality of widgets to generate a monitor result, the first wireless device is utilized for transmitting the monitor result to the second wireless device.

19. The position remote control system of claim 18, wherein the remote controller further comprises a touch display unit, coupled to the second wireless device, for generating a second display signal according to the monitor result received by the second wireless device.

20. The position remote control system of claim 18, wherein the touch panel is further utilized for displaying the positions of the plurality of widgets according to the second display signal to indicate the target position of the selected widget by clicking and dragging on the touch panel.

21. The position remote control system of claim 20, wherein the touch control module is further utilized for generating the touch result according to the selected widget and the target position.

22. The position remote control system of claim 16, wherein the remote controller further comprises a plurality of tuning keypads, coupled to the keypad control module, the keypad control module is utilized for generating the keypad command according to a pressing history of the plurality of tuning keypads, for tuning the target position of the selected widget to generate a tuning result by the keypad command.

23. The position remote control system of claim 16, wherein the touch panel is further utilized for displaying a virtual selection keypad to select one of the plurality of widgets by a clicking operation.

24. The position remote control system of claim 16, wherein the first wireless device and the second wireless device are ultrared devices, wireless fidelity (WiFi) devices or Bluetooth devices.

25. The position remote control system of claim 1, wherein the display module is embedded in the display device, the display device is a television.
